(19) United States
(12) Patent Application Publication
(10) Pub. No.: US 2023/0243382 A1
(43) Pub. Date: Aug. 3, 2023

(54) Connecting Component, Combination of Connecting Components, Monitoring System and Manufacturing Method

(71) Applicant: Hilti Aktiengesellschaft, Schaan (LI)

(72) Inventors: Lukas PFARR, Feldkirch (AT); Slaven RANOGAJEC, Belisce (HR)

(21) Appl. No.: 18/007,933

(22) PCT Filed: May 26, 2021
(86) PCT No.: PCT/EP2021/064068

§ 371 Date: Dec. 2, 2022

(30) Foreign Application Priority Data
Jun. 3, 2020 (EP) 20178019.4

(51) Int. Cl. F16B 31/02; G01L 5/24

(52) U.S. Cl. CPC F16B 31/028; G01L 5/243

(57) ABSTRACT

A connecting component includes a connecting component body, a sensor which is configured to convert a value of a sensor measured variable acting on the sensor into an electrical output variable, and a radio interface which is configured to communicate with a communication device by a radio signal on a basis of the electrical output variable. The sensor is configured to convert the value of the sensor measured variable into the electrical output variable in accordance with a continuous switching stage characteristic having a sensor measured variable threshold value.

### BACKGROUND AND SUMMARY OF THE INVENTION

The invention relates to a connecting component, comprising a connecting component body, a sensor which is set up to convert a value of a sensor measured variable acting on the sensor into an electrical output variable, and a radio interface which is set up to communicate with a communication device by means of at least one radio signal on the basis of the electrical output variable.

U.S. Pat. No. 9,483,674 B1 discloses an RFID tag having a spring element in the form of a washer that can complete or interrupt a circuit depending on the load on the spring element.

The object of the present invention is to provide at least one particularly versatile and inexpensive connecting component of the type in question, a monitoring system having such a connecting component and a manufacturing method for manufacturing such a connecting component.

The invention is achieved by a connecting component, comprising a connecting component body, a sensor which is set up to convert a value of a sensor measured variable acting on the sensor into an electrical output variable, and a radio interface which is set up to communicate with a communication device by means of at least one radio signal on the basis of the electrical output variable, wherein the sensor is set up to convert the value of the sensor measured variable into the electrical output variable in accordance with a continuous switching stage characteristic having at least one sensor measured variable threshold value.

Such a connecting component can be used in a particularly versatile and thus inexpensive manner, for example by adapting the continuous switching stage characteristic. For this purpose, there can be provision for different types of connecting component bodies. A connecting component body can be understood to mean an element intended to connect and/or assist the connection of two components, in particular two components of a structure, for example a washer, a bolt, an anchor and/or a nut. The structure can be, for example, a floor, a wall, a ceiling, a wooden, brick and/or concrete element.

A continuous switching stage characteristic can be understood to mean that the characteristic curve of the sensor, that is to say the sensor measured variable value output variable value curve, has a mathematically continuous trend having at least one inflection point, at least within an intended area of application of the sensor. The areas to the left and right of the inflection point can each correspond to a state, i.e., a switching stage, of the sensor measured variable or the sensor. The curve can have, at least in one section, a sigmoidal or at least substantially sigmoidal trend. The inflection point can be at the sensor measured variable threshold value. The curve can have one or more inflection points. The sensor measured variable or the sensor can thus have two or more, in particular a countable number of, states.

The continuous trend of the curve allows a defined electrical state of the electrical components of the connecting component, in particular of the sensor and/or the radio interface, at any time.

The curve can have a mathematically steep or very steep trend. Thus, the sensor can replicate or at least substantially replicate the behavior of a mechanical switch. In particular, the electrical output variable can indicate a first state, for example a low electrical resistance, or a second state, for example a high electrical resistance, on the basis of the sensor measured variable. Disadvantages of a mechanical switch such as for example wear, radio interference in the generated electrical output variable or the like can, however, be reduced or avoided.

For a simple evaluation of the sensor signal, the electrical output variable can be an electrical resistance value, an electrical capacitance value and/or an electrical inductance value.

The sensor can be set up to detect a force acting on the connecting component and/or a force acting in the connecting component and/or a pressure acting on the connecting component and/or a pressure acting in the connecting component as sensor measured variable. Alternatively or in addition, it is also conceivable for the sensor to be set up to detect a strain, a translation, a rotation, a temperature, a humidity and/or an air pressure as sensor measured variable.

The sensor and/or the radio interface can, in particular additionally, be set up to impress one or more identification codes, for example a type identifier and/or an individual component identifier, into the electrical output variable and/or into the radio signal of the radio interface.

Alternatively or additionally, the connecting component, for example the connecting component body, can have a physical identification feature.

In one class of embodiments of the invention, the sensor measured variable threshold value of the switching stage characteristic is chosen such that proper use of the connecting component and/or of a component to be monitored is accompanied by the sensor measured variable either always exceeding or always being below the sensor measured variable threshold value. For example, in the case of a washer, the sensor of which detects a contact pressure, the sensor measured variable threshold value can be chosen such that when the sensor measured variable threshold value is exceeded, proper seating of a bolt guided through the washer and, for example, installed on a concrete element is ensured and that if the sensor measured variable threshold value is not reached, the bolt is not properly seated.

For this purpose, the sensor measured variable threshold value can be adjustable and/or preset. For this purpose, material properties, shape and/or sizing of the sensor, in particular its sensor material, can be set and/or selected accordingly. In particular, it is conceivable for the sizing and/or the design of the sensor, a sensor material of the sensor and/or at least one electrode of the sensor, in particular the geometry and/or the size of an electrode area, to be chosen on the basis of a parameter of the connecting component, in particular of the connecting component body, and/or a component with which the connecting component is intended to be used. The sensor material can be doped, preferably with at least one, particularly preferably with two different, doping materials. The type and/or density of doping of the at least one doping material can be chosen for setting the sensor measured variable threshold value. The sensor measured variable threshold value can alternatively or additionally also be set by means of a semiconductor component, for example by means of a transistor, and/or by means of an amplifier circuit. For this purpose, it is also conceivable to set an offset point, for example by adding, removing and/or adapting an electrical resistor connected in series or in parallel with the sensor.

The connecting component can have a sandwich structure. For this purpose, the sensor can be completely or at least partially embedded in the connecting component. In particular, it can be arranged between two connecting component layers of the connecting component. The connecting component layers can form a part of the connecting component body or the complete connecting component body. The sensor can be protected against harmful environmental influences, for example, by the connecting component layers. The sensor can be set up to detect parameters of the connecting component body.

The service life of the connecting component can also be extended if the connecting component, in particular its connecting component body, is designed to limit the value of the sensor measured variable acting on the sensor to a minimum value and/or a maximum value. A range of the sensor measured variable that is intended to be detected by the sensor can also be set in this way.

The sensor, in particular the sensor material of the sensor, preferably comprises a polymer, in particular a conductive and/or elastically deformable polymer. The polymer can be an elastomer. The polymer can have a resistance value and/or specific resistance value that is dependent on the sensor measured variable, for example a force- and/or pressure-dependent resistance value and/or specific resistance value. The polymer can comprise at least one doping material.

Particularly preferably, the radio interface is in the form of an RFID tag and/or has an RFID tag. The radio interface can be in the form of a passive radio interface. In particular, the radio interface and/or the sensor can be supplied with energy passively; for this purpose, energy from a radio signal that is collected by the radio interface can be used to supply energy. As an alternative or in addition, the radio interface and/or the sensor can be supplied with energy by an integrated power source such as for example a battery, a storage battery, a solar cell, a thermocouple and/or a fuel cell.

As an alternative or in addition, the radio interface can also be based on a radio standard such as for example WLAN, Bluetooth and/or a low-power radio standard and/or have an applicable module that operates in a radio-standard-specific manner.

In the case of a particularly inexpensive connecting component, there can be provision for the sensor to form and/or comprise a part of the radio interface. If the radio interface has a resonant circuit, the sensor can, for example, influence the resonant frequency, the quality and/or the impulse response of the resonant circuit on the basis of the sensor measured variable. In particular, the electrical output variable can act on the resonant circuit, in particular on its resonant frequency, its quality and/or its impulse response. The switching stage characteristic means that such integration of the sensor, for example in the case of a radio interface in the form of an RFID tag and/or containing such a tag, allows a sabotage loop interface, i.e., a “tamper loop interface”, to be implemented.

The connecting component, in particular the connecting component body, can be in the form of at least one bolt, in the form of at least one anchor and/or in the form of at least one washer and/or can have at least one bolt, at least one anchor and/or at least one washer. The connecting component body can be formed from two washers, for example.

The connecting component can furthermore have at least two sensors which are each set up to convert a value of a sensor measured variable acting on the respective sensor into an electrical output variable. The sensors can detect similar sensor measured variables or, alternatively, different types of sensor measured variables. It is thus also conceivable to connect the radio interface to multiple instances of the at least two sensors. The connection can be made in wired fashion. For example, such a design allows multiple connecting component bodies, which can be arranged at different locations on a component, to each be assigned a sensor. The electrical output variables of the individual sensors can act on and/or be supplied to a common radio interface.

It is also conceivable for the connecting component to have at least one casing. The connecting component body, the radio interface and/or the sensor can be arranged at least partially, preferably completely, in the casing.

In addition, the connecting component can have a position determination component, for example a satellite-assisted position determination component, a nonvolatile and/or a volatile data memory, an A/D converter unit and/or a processor unit. The A/D converter unit can be in the form of a 1-bit A/D converter, for example by means of a Schmitt trigger.

The scope of the invention also includes a combination of at least a first connecting component according to the invention with a first sensor and a second connecting component according to the invention with a second sensor, wherein the first sensor measured variable threshold value of the switching stage characteristic of the first sensor differs from the second sensor measured variable threshold value of the switching stage characteristic of the second sensor. The first and/or the second sensor measured variable threshold value can be chosen on the basis of properties of the respective associated connecting component and/or on the basis of another connecting component and/or component, in particular located in physical proximity. For example, the sensor measured variable threshold values can be chosen on the basis of a minimum contact force required for correct seating of the respective connecting component body and/or generally on the basis of a predefined setpoint value for the respective sensor measured variable.

The scope of the invention also includes a monitoring system, comprising at least one connecting component according to the invention and at least one communication device which is set up to communicate with the radio interface of the connecting component. The monitoring system can have multiple connecting components according to the invention. The communication device can then be set up to communicate with multiple instances of the connecting components at the same time and/or quasi-simultaneously. The communication can take place in individual cases and/or repeatedly, for example at regular intervals of time. The communication device can be set up to receive and/or transmit energy and/or data from the connecting component, in particular from the radio interface thereof.

In particular, the communication device can be set up to receive and/or evaluate data pertaining to the electrical output variable and/or pertaining to the value of the sensor measured variable of the sensor of the connecting component, pertaining to at least one identification code, for example a type identifier and/or an individual component identifier of the connecting component, and/or pertaining to at least one item of position information. It is also conceivable for the communication device to be set up to locate a connecting component on the basis of a gradient of the signal strength of its radio signal.

The communication device can have a display unit. The display unit can be used to present one or more of the received and/or evaluated data. In particular, received and/or evaluated data from multiple connecting components can be presented on the display unit at the same time.

The communication device can be set up to communicate with further tools and/or machines. It is thus conceivable for the communication device to communicate with an installation tool and to monitor and/or control an installation process at least until proper installation of the connecting component is detected. It is also conceivable for the communication device to be set up to communicate with a computer system in order, for example, to retrieve, transmit and/or interchange CAD and/or BIM (Building Information Modeling) data.

The monitoring system can be in cloud-based form. For this purpose, the communication device and/or the radio interface of the connecting component can be set up to communicate with a remote computer system, for example via the Internet.

The communication device can be in mobile, in particular portable, form. Alternatively, it can also be permanently installable and/or installed.

Particularly preferably, the communication device or at least a part of the communication device can be arranged on and/or in a mobile, in particular an unmanned or manned, mode of transport, for example a vehicle and/or a flying object. If the communication device is arranged on a drone, for example, even large structures such as bridges or high-rise buildings having a large number of connecting components according to the invention can have data from these connecting components queried. Thus, even such a large structure can be monitored quickly, easily and inexpensively, in particular monitored remotely.

It is conceivable for the monitoring system to be used to check the correct installation of the connecting component body of the connecting component and/or to check the correct installation of a component to be monitored, for example to check the proper seating of an anchor on which a connecting component in the form of a washer is arranged. It is also conceivable for the monitoring system to be used to continuously and/or regularly check the connecting component body and/or the component, in particular over the expected service life of a connection that has been made.

The scope of the invention also includes a manufacturing method for manufacturing a connecting component according to the invention, wherein the sensor measured variable threshold value of the switching stage characteristic of the sensor of the connecting component is chosen on the basis of a setpoint value for the sensor measured variable. Thus, the characteristic curve of the sensor can be individually matched to the connecting component or to the connecting component body and/or to the component to be monitored right at the time of manufacture. For example, a sensor of the connecting component that measures a contact force of the connecting component body can thus be set up right at the time of manufacture to detect whether or not the connecting component body is installed with a contact force sufficient for correct seating. If a communication device queries one or more such connecting components, the incorrectly seated connecting components can be identified without the communication device requiring type information or the like for the queried connecting components.

Further features and advantages of the invention emerge from the following detailed description of exemplary embodiments of the invention, with reference to the figures which show details essential to the invention, and from the claims. The features shown there are not necessarily to be understood as true to scale and are shown in such a way that the special features according to the invention can be made clearly visible. The various features can be implemented individually or collectively in any combination in variants of the invention.

Exemplary embodiments of the invention are shown in the schematic drawings and are explained in more detail in the description below.

### BRIEF DESCRIPTION OF THE DRAWINGS

FIG. 1 shows a connecting component in a plan view;

FIG. 2 shows a schematic sectional view of the connecting component;

FIG. 3 shows a basic circuit diagram of the connecting component;

FIG. 4 shows a graph of a characteristic curve for a sensor;

FIG. 5 shows a schematic representation of a monitoring system; and

FIG. 6 shows a flowchart for a manufacturing method.

### DETAILED DESCRIPTION OF THE DRAWINGS

To facilitate understanding, the same reference signs are used below for elements that are functionally equivalent.

FIG. 1 shows a connecting component 10 in a plan view. The connecting component 10 has a connecting component body 12 in the form of a washer and a casing 14.

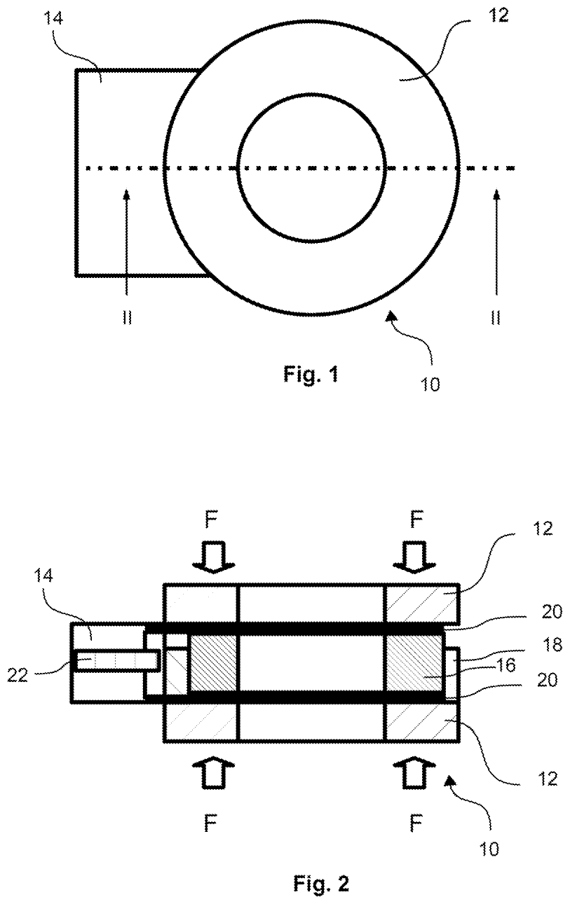

A sectional view of the connecting component 10 corresponding to the section line II is shown in FIG. 2.

The sectional view reveals that the connecting component body 12 is formed from two connecting component layers. A sensor 16 is arranged between these connecting component layers.

The sensor 16 is in the form of a pressure sensor. For this purpose, it is set up to convert a compressive force F acting on the connecting component 10, as sensor measured variable, into an electrical resistance value as electrical output variable. For this purpose, the sensor 16 has a sensor material consisting of an elastically deformable and electrically conductive polymer. The polymer is doped with a doping material, in particular with nanoparticles.

Depending on the acting compressive force F, the connecting component body 12 and thus also the sensor 16 are therefore pressed together. A stiff travel limiting element 18, which can be part of the connecting component body 12, limits the maximum possible compression of the sensor 16. The travel limiting element can therefore protect the sensor 16 from being overloaded by an excessively high compressive force F.

Electrodes 20 electrically connect the sensor 16 to a radio interface 22. The radio interface 22 is arranged in the casing 14. In order to allow the radio interface 22 to communicate with the surroundings, the casing 14 is in nonshielding form, at least with respect to the radio technology used in the radio interface 22.

The radio interface 22 is in the form of an RFID tag. It is set up for operation in an ultra-high-frequency (UHF) frequency range.

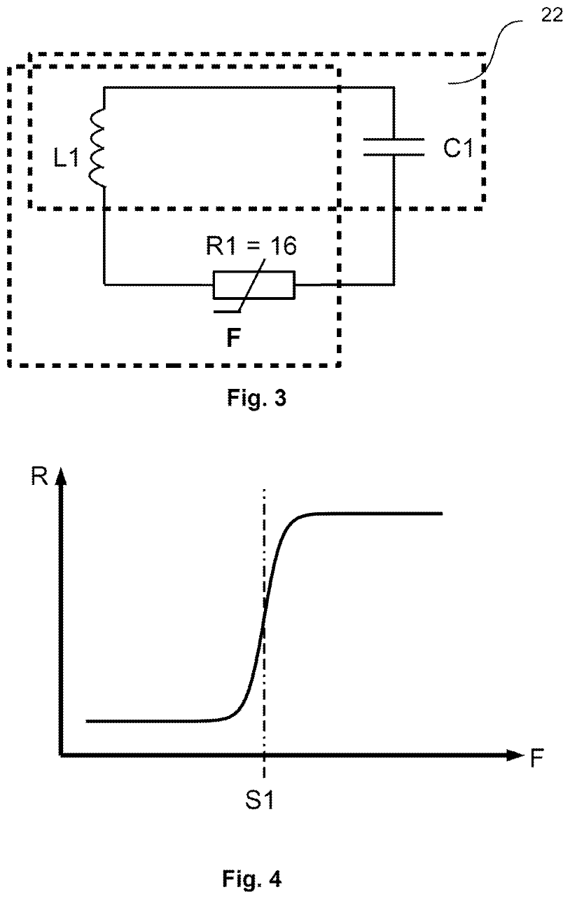

A basic circuit diagram of the connecting component 10 (FIG. 1) is shown in FIG. 3.

The radio interface 22 has, as indicated by a dashed rectangle in FIG. 3, an inductance L1 and an electrical capacitance C1. These components L1 and C1 form a resonant circuit. A variable resistor R1, which, here, is variable on the basis of the compressive force F (FIG. 2), is integrated in the resonant circuit. The resistor R1 corresponds to the sensor 16 (FIG. 2).

The resistor R1, i.e., the sensor 16, influences the quality and the impulse response of the resonant circuit and thus of the radio interface 22.

The inductance L1 is in the form of a magnetic antenna, as a result of which it can be used to couple a radio signal and thus in particular energy into the resonant circuit and to emit a radio signal.

A further dashed rectangle in FIG. 3 shows that the variable resistor R1, i.e., the sensor 16, can form a part of the inductance L1 or the entire inductance L1. For this purpose, the inductance L1 can be formed from the sensor material. It would also be conceivable for the sensor 16 to form a part of the capacitance C1 or the entire capacitance C1.

FIG. 4 shows a graph of a characteristic curve for the sensor 16 (FIG. 2) in the form of a force F/resistance value R curve. The force F/resistance value R curve exhibits a continuous trend. It has a sigmoid trend with a sensor measured variable threshold value S1. The sensor measured variable threshold value S1 corresponds to the abscissa of the inflection point of the force F/resistance value R curve. The force F/resistance value R curve exhibits a steep trend. The sensor 16 thus essentially has two states, a low-resistance state and a high-resistance state with respect to the electrical output variable. The low-resistance state corresponds to compressive forces F below the sensor measured variable threshold value S1. The high-resistance state corresponds to compressive forces F above the sensor measured variable threshold value S1. The low-resistance state can correspond to resistance values R of, for example, 10⁰ ohm to 1×10⁷ ohms. The high-resistance state can correspond to resistance values R of, for example, 2×10⁷ ohms to 10⁹ ohms. For example, the sensor measured variable threshold value 51 can have an associated resistance value R of 20 Mohms. The sensor 16 can thus function in the manner of an electrical switch. The continuous trend nevertheless results in a defined, finite and non-negligibly low resistance value R at all times and in particular for every compressive force F acting on the sensor 16.

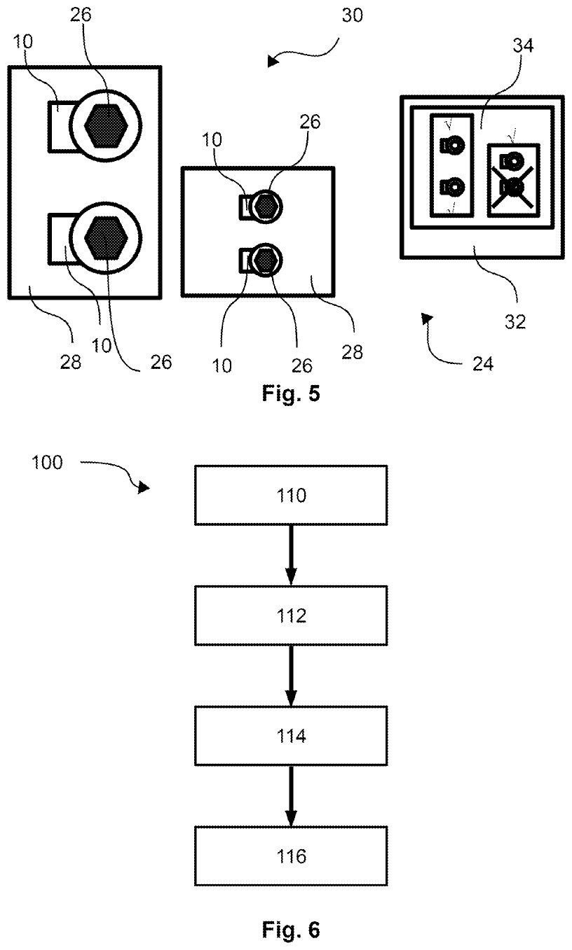

FIG. 5 shows a schematic representation of a monitoring system 24. It is necessary to monitor the proper seating of multiple anchors 26 intended to fix different components 28. The anchors 26 are each provided with connecting components 10 in the form of washers, which correspond to the connecting components 10 described above. Some of the anchors 26 have different sizes and require individually different, defined minimum tightening torques for proper seating. The connecting components 10 assigned to each of them have different sensor measured variable threshold values S1 (FIG. 4) adapted for the respectively required minimum tightening torques. The resonant frequencies of the resonant circuits formed by the respective inductances L1 and capacitances C1 (both FIG. 3) are chosen individually as identification codes for identifying the connecting components 10 and thus their associated anchors 26.

The connecting components 10 form a combination 30 of connecting components 10.

The monitoring system 24 also has a communication device 32. This has a display unit 34. The communication device 32 is set up to communicate with all connecting components 10 located within a specific transmission and reception area, here by way of example with all connecting components shown in FIG. 5. For this purpose, it emits a first radio signal, which is received by the connecting components 10 and supplies the electronic elements of the connecting components 10 with energy. Depending on the respective electrical output variable, i.e., depending on the electrical resistance value R (FIG. 4) of the sensor 16 and thus depending on the contact force that acts on the respective connecting component 10 and depending on the sensor variable threshold value 51, the connecting components 10 then emit response radio signals. One or more of the connecting components 10 can also be set up so that no or at least no valid response radio signal is emitted in the high-resistance state. The response radio signals are in turn received and evaluated by the communication device 32; in particular, the communication device identifies the respective transmitting connecting components 10, for example by analyzing the frequency spectra of the response radio signals. The communication device 32 can also be set up to detect the absence of a response radio signal from one or more of the connecting components 10.

The communication device 32 then presents the results of the evaluation on the display unit 34. In the example according to FIG. 5, the presentation in this regard shows that three of the four connecting components 10 are seated properly, but one is not.

FIG. 6 shows a flowchart for a manufacturing method 100 for manufacturing a connecting component 10 corresponding to the connecting components described above (FIG. 1). The manufacturing method 100 is explained in more detail by way of example with reference to the previously described connecting component 10 embodied in the form of a washer. The reference signs used hitherto continue to be used below to facilitate understanding.

In a first step 110 a setpoint value for the sensor measured variable of the sensor 16 is stipulated. The setpoint value defined in this exemplary embodiment, in which the sensor measured variable corresponds to the contact force F, is the minimum contact force required for proper seating of an anchor guided or to be guided through the connecting component body 12.

In a next step 112 the sensor measured variable threshold value 51 of the switching stage characteristic of the sensor 16 of the connecting component 10 is chosen on the basis of the setpoint value of the sensor measured variable. For this purpose, an electrically conductive and elastically deformable polymer doped with nanoparticles with a pres sure-dependent specific resistance value and a sigmoidal or at least essentially sigmoidal force F/resistance value R curve is selected as the sensor material and shaped to match the connecting component body 12. The type and density of the doping are chosen such that the sensor measured variable threshold value 51 corresponds to the setpoint value stipulated in step 110.

In a next step 114 the connecting component 10 is assembled. For this purpose, prefabricated individual parts of the connecting component body 12, the casing 14, the sensor 16, including the described sensor material, the travel limiting element 18, the electrodes 20 and the radio interface 22 are fitted together and, if necessary, electrically connected to one another. Designing the travel limiting element 18 involves ensuring that compression of the sensor 16 at least up to the force F corresponding to the sensor measured variable threshold value 51 remains possible.

In a concluding step 116 a final check on the connecting component 10 is performed by impressing forces F, subsequently reading the data via the radio interface 22 and comparing the data with the requirements according to the stipulated setpoint value. In particular, the sensor measured variable threshold value 51 obtained can be determined and checked in this step.

It is conceivable, for example in step 114, to additionally impress a specific identification code on the connecting component 10. It is then possible, for example in step 116, to additionally check whether the specific identification code can be queried and/or whether the queried identification code matches the determined sensor measured variable threshold value 51.

1.-15. (canceled)

16. A connecting component, comprising:
a connecting component body;
at least one sensor which is configured to convert a value of a sensor measured variable acting on the sensor into an electrical output variable; and
a radio interface which is configured to communicate with a communication device by a radio signal on a basis of the electrical output variable;
wherein the sensor is configured to convert the value of the sensor measured variable into the electrical output variable in accordance with a continuous switching stage characteristic having a sensor measured variable threshold value.

17. The connecting component as claimed in claim 16, wherein the electrical output variable is an electrical resistance value, an electrical capacitance value, or an electrical inductance value.

18. The connecting component as claimed in claim 16, wherein the sensor is configured to convert a force acting on the connecting component and/or a force acting in the connecting component and/or a pressure, as the sensor measured variable, into the electrical output variable.

19. The connecting component as claimed in claim 16, wherein the sensor measured variable threshold value is chosen such that a proper use of the connecting component and/or of a component to be monitored is accompanied by the sensor measured variable either always exceeding or always being below the sensor measured variable threshold value.

20. The connecting component as claimed in claim 16, wherein the sensor is completely or at least partially embedded in the connecting component body.

21. The connecting component as claimed in claim 16, wherein the connecting component body is configured to limit the value of the sensor measured variable acting on the sensor to a minimum value and/or a maximum value.

22. The connecting component as claimed in claim 16, wherein the sensor comprises a conductive polymer and/or an elastically deformable polymer.

23. The connecting component as claimed in claim 16, wherein the radio interface is an RFID tag or has an RFID tag or is a passive radio interface.

24. The connecting component as claimed in claim 16, wherein the sensor forms the radio interface or comprises a part of the radio interface.

25. The connecting component as claimed in claim 16, wherein the connecting component body is a bolt or is an anchor or is a washer or has a bolt or has an anchor or has a washer.

26. The connecting component as claimed in claim 16, wherein the connecting component has at least two sensors which are each configured to convert a value of a sensor measured variable acting on the respective sensor into an electrical output variable.

27. An apparatus, comprising:
a first connecting component as claimed in claim 16; and
a second connecting component as claimed in claim 16;
wherein the sensor measured variable threshold value of the first connecting component differs from the sensor measured variable threshold value of the second connecting component.

28. A monitoring system, comprising:
the connecting component as claimed in claim 16; and
a communication device which is configured to communicate with the radio interface of the connecting component.

29. The monitoring system as claimed in claim 28, wherein the communication device or at least a part of the communication device is disposed on a mobile mode of transport or in the mobile mode of transport and wherein the mobile mode of transport is a vehicle or a flying object.
